(19) United States
(12) Patent Application Publication
(10) Pub. No.: US 2007/0242749 A1
(43) Pub. Date: Oct. 18, 2007

(54) Image frame compression of video stream with fast random accessing and decompressing

(76) Inventor: Chih-Ta Star Sung, Glonn (DE)

Correspondence Address: Chih-Ta Star SUNG;RM. 308, BLD. 52, NO. 195, CHUNG HSING RD., SEC. 4, CHU TUNG TOWNSHIP, HSINCHU COUNTY, 310, TW

(21) Appl. No.: 11/404,246

(22) Filed: Apr. 14, 2006

(51) Int. Cl. H04N 11/02; H04N 7/12

(52) U.S. Cl. 375/240.16; 375/240.26

(57) ABSTRACT

An image frame of a video stream is compressed area by area with at least two areas having different bit rates. When compressing an area of the current frame pixels, the bit rate information of the corresponding area of previous frame which is referred which is saved in a temporary storage device. The bit rate information of each area is inserted into the predetermined location of the compressed image bit stream to allow fast random accessing and pipelining decompressing pixels in any area.

### BACKGROUND OF THE INVENTION

1. Field of Invention

The present invention relates to method and apparatus for reducing data rate of image pixels, and particularly relates to compression and decompression of image frame of the displaying video stream with fast random accessing any line of pixels.

2. Description of Related Art

The digital image and motion video have been adopted in an increasing number of applications, which include digital camera, scanner/printer/fax machine, video telephony, videoconferencing, 3G mobile phone, VCD (Video CD), DVD, digital TV . . . etc. The success of development of the digital image and video compression standards including JPEG, a still image compression standard set by ITU and the MPEG, the motion video compression standard set by the ISO have played key role for the digital image and video applications. Both JPEG and MPEG are lossy algorithms which when being decompressed, the image data are different from the original ones. And the bit rate of each image frame is variable depending on the complexity of the image pattern.

In the television, DVD, STB, Set-Top-Box, 3G mobile phone or other portable devices, a decompressed video stream of continuously image will be temporarily saved into a storage device for other manipulation including scaling and deinterlacing before being sent to a display device. In these kind of applications, a fixed bit rate of compressed image is expected for convenience of allocating fixed density of the storage device or/and allocating fixed bandwidth of accessing the storage device during a pre-scheduled time slot. Fixed bit rate of a compressed image frame provides necessary performance of random accessing pixels of any area with a fixed density of storage device which results in the saving of cost and power consumption. Since these image frames temporarily saved in the storage device will be used as references in the further image frames, keeping good quality is required for ensuring the good image quality for a video stream.

Therefore, it is beneficial to reduce the bit rate of an image frame of a video stream with fixed bit rate of an image while still keeping good image quality for further image frames' reference. The capability of being quickly random accessed and decompressed pixels of any area of an image enhances the performance of other manipulation including scaling, deinterlacing and displaying.

### SUMMARY OF THE INVENTION

The present invention is related to a method and apparatus of the image frame compression of the video stream, which plays an important role in image data reduction for the display device controller. The present invention significantly reduces required storage device density, on-chip image buffer and accessing bandwidth of the image within the storage device.

The present invention of the image frame compression takes the advantage of only little difference between adjacent frames and compresses the current frame by referring to the bit rate information of each area of the previous frame.

According to an embodiment of this invention, the bit rate information of each area within a frame is saved into a temporary storage device and when compressing the current image, the bit rate information of the corresponding area of previous image is referred.

According to an embodiment of this invention, the bit rate information of each area within a frame is saved into a temporary storage device and when compressing the current image, the bit rate information of the corresponding area of previous image is referred.

According to another embodiment of the present invention, each area of compressed pixels has different bit rate.

According to an embodiment of the present invention, a predetermined length of code is assigned to represent the bit rate of each area of an image, and the codes are inserted into the predetermined location of an image stream.

According to an embodiment of the present invention, during random accessing any area, the starting location of the selected area within storage device is calculated firstly, and then, the pixels are decompressed in pipelining.

According to another embodiment of the present invention, a threshold value is predetermined to decide whether the bit rate allocation of an area of the current image should refer to the bit rate of the bit rate information of the previous image.

It is to be understood that both the foregoing general description and the following detailed description are by examples, and are intended to provide further explanation of the invention as claimed.

### BRIEF DESCRIPTION OF THE DRAWINGS

FIG. 1 illustrates the prior art of image frame compression with constant bit rate of each line.

FIG. 2 illustrates an image frame compression with variable bit rate of each line/area and a predetermined frame bit rate.

FIG. 3 illustrates the video stream showing little difference from frame to frame.

FIG. 4 shows the procedure of compressing an image frame with reference of bit rate information of each area of previous image frame of video stream.

FIG. 5 lists a table of an example of bit rate information

FIG. 6 shows how a compressed image stream is organized with bit rate information inserted.

FIG. 7 illustrates how the starting location of each area (or line) can be calculated and pixels being quickly decompressed.

FIG. 8 depicts the procedure of deciding whether an image frame can be compressed by referring to bit rate information of the previous frame.

### DESCRIPTION OF THE PREFERRED EMBODIMENTS

Some display device require high density of the storage device to temporarily saving the decompressed image(s) generated from a MEPG/JEPG decoder. Most of the storage devices are used to save the image frame for quality enhancement manipulation including image scaling and deinterlacing. Especially the later, for achieving high quality, at least three previous frames of image are saved for image compensation to reconstructing the current image frame. Quickly accessing pixels of any area within image frame becomes very challenging task which requires high I/O bandwidth.

This invention of the image frame compression of the video stream reduces the bit rate of the image frame by assigning a fixed bit rate of an image frame with the capability of quickly random accessing and decompressing pixels of any area, for example, any line.

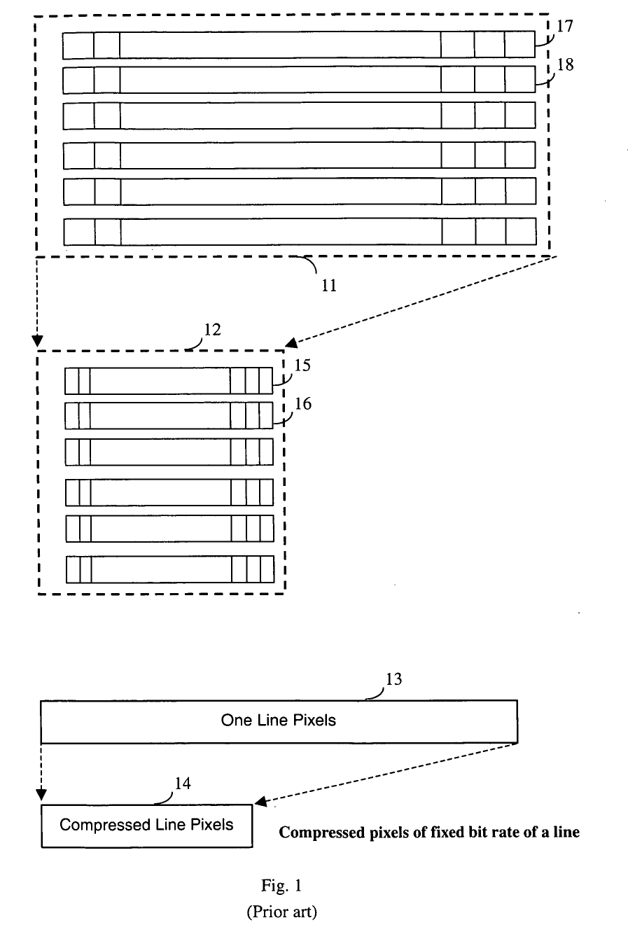

FIG. 1 illustrates a prior art of image compression. An image frame 11 is comprised of a certain numbers of lines of pixels 17, 18. In this prior art image compression, each line of pixels 13 is compressed with fixed bit rate 14, for instance, 2.0X compression rate and comes out of a fixed length of bits of each line 15, 16 and together forms the compressed image with fixed bit rate 12. The advantage of this prior art image compression with fixed line compression rate is that this scheme allows quickly accessing and decompressing any line of pixels. The disadvantage of this prior art of image frame compression is lack of flexibility of allowing more bits for lines with more complex pattern which might be difficult in compressing pixels to a predetermined bit rate.

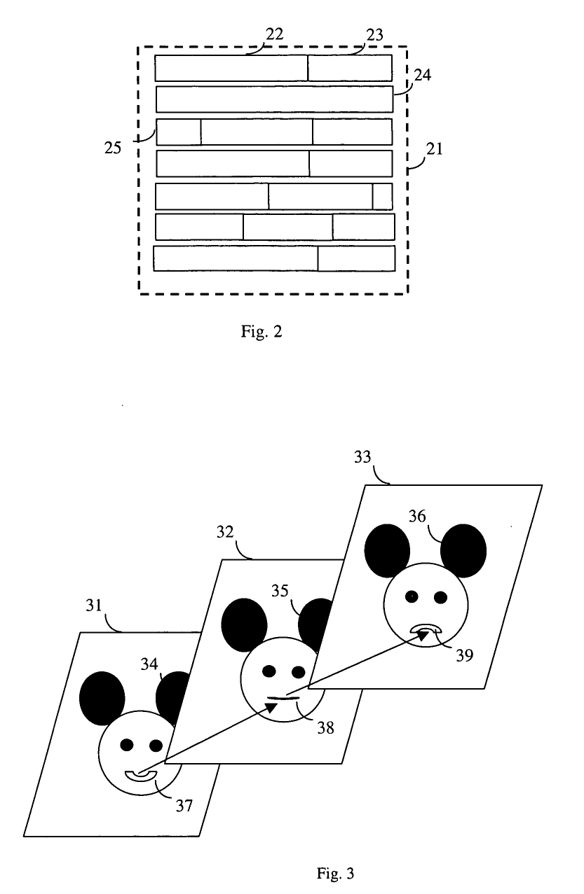

FIG. 2 shows a basic of another image compression method of this invention of image frame compression. Those lines with shorter bit rate 22, 23, are line having simple patterns which saves more bits to be shared with the line with more bit rate 24, 25 of more complex patterns. Together, this variable length of bits of each line of pixels forms a fixed bit rate of an image frame.

This invention of image frame compression takes another feature of little change between adjacent image frames as shown in FIG. 3. The continuous image frames 31, 32, 33 have high possibility of the same background 34, 35, 36 of views and even the motion parts have only partial area having movements 37, 38, 39 in a short period of time of adjacent frames. In a short period of time of a continuous image frames, there are high similarity of each area of an image frame from frame to frame.

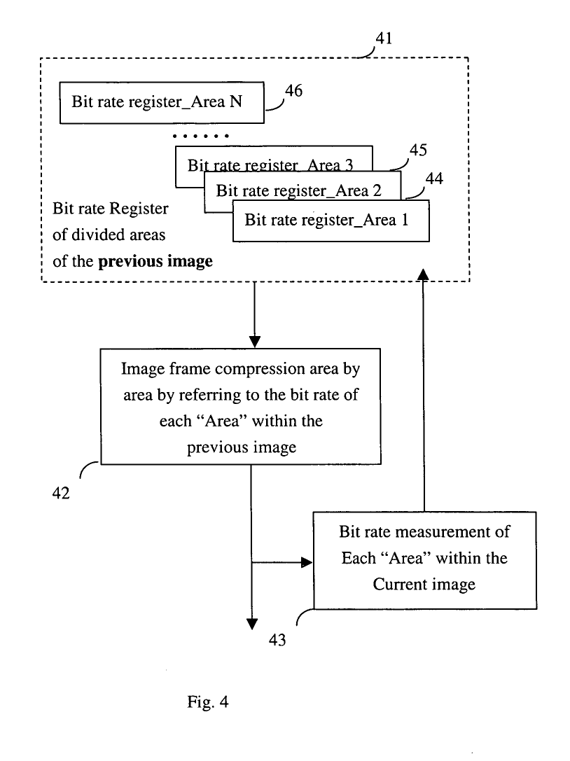

In prior art image frame compression shown in FIG. 1, the difficulty in compressing an image frame is the unpredictable bit rate allocation, hence and can only assign fixed number to each area/line. This invention of image frame compression takes advantage of little change between adjacent frames and allocate bit rate from area to area according to the previous image frame. FIG. 4 illustrates the procedure of image frame compression area by area with reference of bit rate of previous frame. After compression, each “Area” (for example a “Line”) bit rate is calculated and rounded to a predetermined length 43 before being saved into a bit rate register 41 which is comprised of area bit rate registers 44, 45, 46 with fixed bit rate for each area.

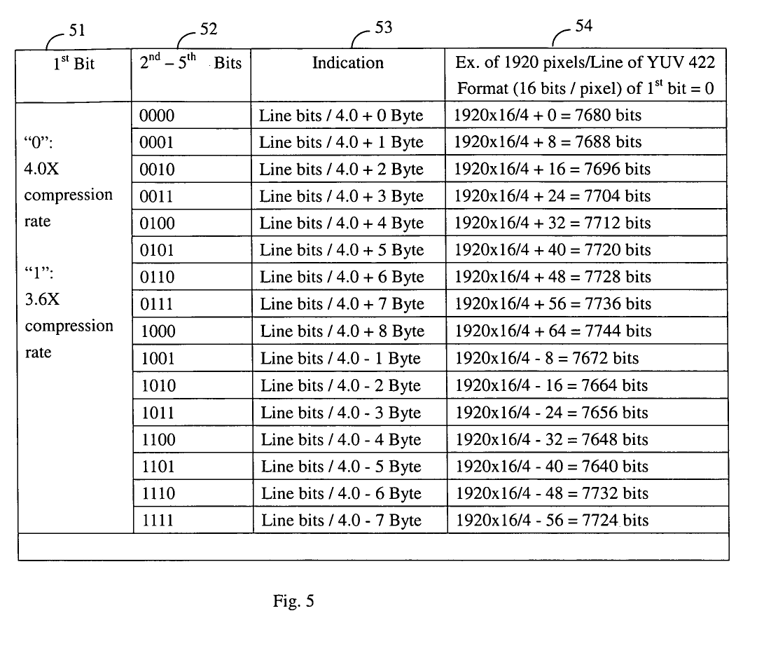

FIG. 5 shows a list of an example of coding of the bit rate of an area, said for example, a line with base of a fixed bit rate of each area 51, for example the 1^{st} bit represents 4.0X (if “0”) or 3.6X (if “1”) compression rate. The 2 md to 5^{th} bits 52 of the code represents a known bit rate of a line plus or minus the value of the code times 8 bits or said a “Byte” 53. For instance, the code of “0 0000” represent bit rate of 4.0X compression of a line plus 0 Byte, “0 0001” represent bit rate of 4.0X compression of a line plus 1 Byte, “0 0010” represent bit rate of 4.0X compression of a line plus 2 Byte, “1 0001” represent bit rate of 4.0X compression of a line minus 1 Byte, . . . If a line is comprised of 1920 pixels 54 with 4:2:2 YUV format which represents 16 bits per pixels, the code of “0 0000” represent bit rate of 4.0X compression of a line plus 0 Byte equals to 7680 bits, and the code of “0 0001” represents 7688 bits . . . the code of “0 0001” represents 7724 bits. For simplicity and easy accessing, the “Byte”, “Word” or “Double Word” boundary is selected to represent the even number of bit rate of an area of an image frame. Should the bit rate of an area does not fit exactly the Byte, Word or Double Word boundary, some dummy codes are inserted or the code beyond the meaningful bits are ignored in decompressing.

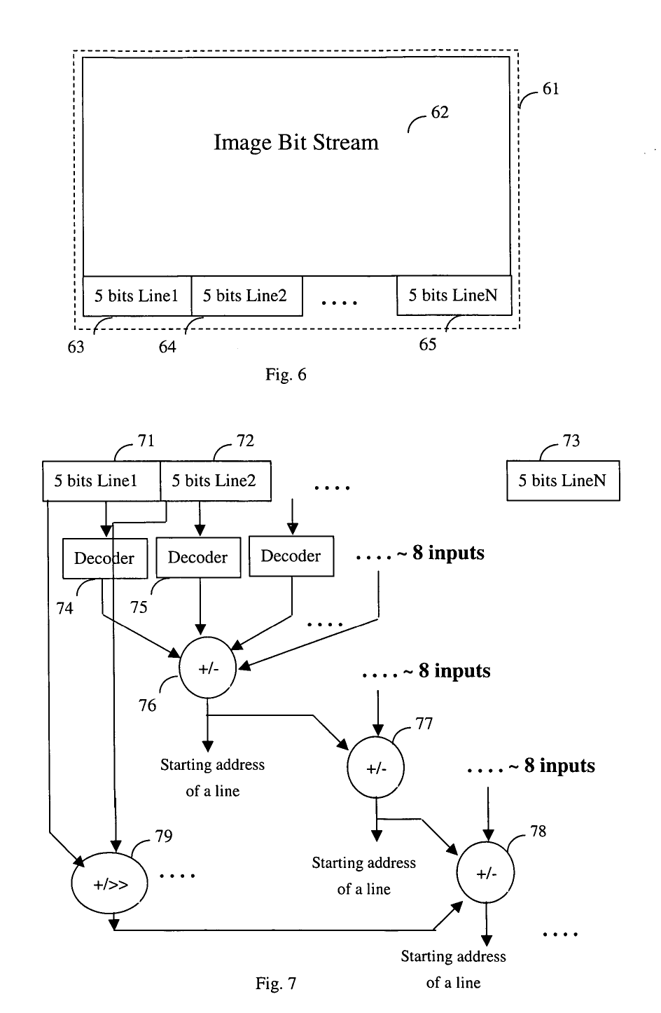

With the code of bit rate of each area/line, random accessing any area or line becomes easy and costs only a short of time to access by decoding and calculating the starting location of each area/line. FIG. 6 depicts the bit stream organization of this invention of the image frame compression 61 which comprises the compressed information image frame 62 followed by code 63, 64, 65 of bit rate indication of each area. The code of bit rate of each area is copied from the register saving the bit rate information of each area.

FIG. 7 illustrates the mechanism of quickly accessing any area or line of a compressed image frame. Codes 71, 72, 73 of bit rate information are inserted to a predetermined location of a compressed image frame which is most likely in the end of a compressed image. For fast accessing, each area/line of an image frame uses a decoder 74, 75 to decode and calculate the total bit number 76 of each area/line. The calculated bit number of each line can be added 77, 78 to become an accumulative starting location of any area. Since the chain and accumulative delay of decoding and calculating might be longer than the time of one clock cycle, a predetermined number of continuous areas of pixels is clustered as a group of areas which reduces one clock cycle time to decode and calculate the starting location of any selected area. For example, if an image frame has 1920 lines, for a code of 5 bits with the 2^{nd} to 5^{th} bits representing the bit rate of each line and the 1^{st} bit as a compression rate of 4.0X or 3.6X, the total of delay time of the cascaded gate can be longer than 3-4 clock cycles. If every 512 lines are clustered into a group, there will be a total of 4 clocks cycles needed to decode any line of a compressed image frame with each cycle time decoding starting location of about 480 lines. The starting location of any the 480 lines can be hierarchically decoded by 3 levels with each having 8 inputs of bit rate values. All 5 bits of code representing the bit rate of each area or each line can be decoded and calculated together.

The 1^{st} bit of the bit rate code can be fixed to indicate two compression rate, for example a 4.0X and another 3.6X. The accumulative addition of the line bit rate can be calculated separately from the other 4 bits of bit rate variance. In the end of the last stage of addition, the result of the line lengths 79 are added with the bit rate variance of each line which can be calculated by “Addition” and “Shifting” instead of long chain of addition.

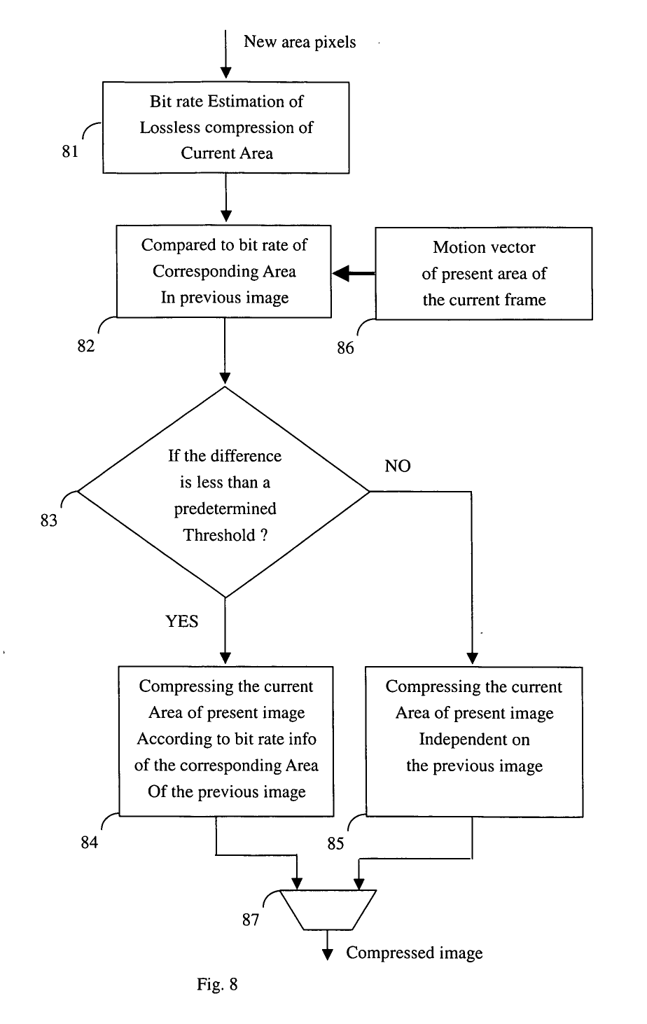

Even the bit rate information of previous image frame helps in bit rate allocation of the current frame, those pixels in the area with no correlation from corresponding area of the previous image should not be compressed with referring to previous frame. FIG. 8 depicts the flow chart of the decision making on whether or not the bit rate allocation of the present area refers the bit rate information of the corresponding area in previous image frame. Pixels of a new area are examined and calculated the bit rate 81 of applying a lossless compression algorithm. The bit rate number is then compared to that of the corresponding area 82 of the previous image. The “Corresponding Area” might be a shifted area with the displacements of X- and Y-axis according to the motion vector 86 of the present area of the current image frame. If the difference is under the predetermined threshold value, then, compressing the current area of pixels by referring to the bit rate information of the corresponding area of the previous image frame 84, of the difference value is over the threshold, then, compressing the present area independent on the previous image frame 85. Some areas will be compression with reference of previous image, some will be independent on the previous image and a MUX 87 selects which result to be the output of the compressed area. For simplicity, the majority of the motion vectors of area within an image frame can be used to represent the “Frame Motion Vector” since most likely, the movement within a frame are the same. In practical implementation of this invention of the image frame compression of a video stream, the line by line compression either from top to down or from bottom to up is most common mechanism and the X-axis is the most concerned motion displacement for the corresponding area (or line) and the corresponding area (or line) is calculated accordingly. For obtaining more accurate bit rate allocation, both X- and Y-axis are referred.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method for manipulating at least one received image frame of decompressed video stream before being sent to a display device, comprising:
compressing the first image frame pixels with a predetermined bit rate;
saving the bit rate information of each predetermined area within the first image frame into the temporary storage devices; and
compressing the second image frame with the area bit rate allocation referring to the bit rate information of the corresponding area of the first image frame.

2. The method of claim 1, wherein at least two areas of the compression units have not the same compressed bit rate.

3. The method of claim 1, wherein during saving the bit rate of each area of the current image frame, a predetermined code length is assigned to represent the bit rate of each area of the current image frame.

4. The method of claim 1, wherein the bit rate numbers of each area are temporarily saved in a storage device and are copied to the predetermined location of the compressed image stream.

5. The method of claim 3, wherein the code of bit rate indication of each area are separately representing the compression rate of each area plus some codes representing the variance of length in Byte, Word or Double Word boundary.

6. The method of claim 1, wherein the corresponding area of an image under compression is calculated by referring to the motion vector of those corresponding pixels in the area.

7. The method of claim 1, wherein the corresponding area of an image under compression is calculated by referring to the motion vector of the majority of motion vector values within the present image frame.

8. A method for compressing and decompressing an image frame with fast random accessing any area of pixels, comprising:
compressing the pixels, area by area, with reference of the corresponding area of the previous image frame;
calculating the bit rate of each area and storing the corresponding bit rate information of each area to a temporary storage device;
loading the bit rate information from the temporary storage device of each area and storing to the predetermined location within a compressed image stream; and
calculating the starting location of each area within an image frame which pixels are to be accessed and decompressing the compressed data in a pipelining mechanism.

9. The method of claim 8, wherein the code representing bit rate of each area has predetermined length which times 8 bits, 16 bits or 32 bits plus the original bit rate of an area divided by compression rate represented by at least one bit, equals to the bit number of a compressed area.

10. The method of claim 8, wherein in calculating the starting location of any area of an image frame, a hierarchical calculation mechanism is applied to reduce the delay time of accessing time.

11. The method of claim 8, wherein in calculating the starting location of a compressed image frame, a predetermined amount of areas pixels are clustered as a “Group” and the bit rate codes are input to a first calculator, a certain amount of “Groups” bit rates are clustered as a “Macro Group” and input to a second calculator, and a certain amount of “Macro Groups” bit rates are clustered as a “Macro-Group” and input to a third calculator to calculate the final starting location of any area to be accessed.

12. The method of claim 8, wherein the accessed compressed pixel data are decompressed in pipelining scheme to provide the highest throughput.

13. The method of claim 8, wherein at least one of the bit rate indication code represent the compression rate and coupled with other bits of the code represent the bit rate variance of an area and forms the starting location of an area of pixels.

14. The method of claim 8, wherein should the bit rate of lossless compression of the area is of the current image is less higher than a predetermined threshold of the corresponding at least of the previous image frame, that area pixels will be compressed independent on the previous image.

15. An apparatus for compressing an image frame with fast random accessing and decompressing any area of pixels within the compressed image frame, comprising:
a compressor reduces the data rate of pixels area by area by referring to the bit rate information of the corresponding area of previous image frame;
a counting circuitry calculating the bit rate of each area and storing the bit rate information of each area to a temporary storage device as the reference for compressing the following image;
another circuitry calculating the starting location of each area within a compressed image which pixels are to be accessed;
and a decompression unit reconstructing the pixels data in a pipelining mechanism and continuously outputting the recovered pixels.

16. The apparatus of claim 15, wherein the bit rate counting circuitry is comprised of at least a calculating circuit of counting the area bit rate of each area and a calculating unit to measure the compression rate and to round the compression rate to a predetermined value.

17. The apparatus of claim 15, wherein the levels of hierarchical calculation of bit rate is predetermined based on the time delay of each level and the total number of lines of an image frame.

18. The apparatus of claim 15, wherein the storage devices used to temporarily saving the bit rate information of each area is comprised of data flip-flop or so named register.

19. The apparatus of claim 15, wherein the codes of bit rate indication of each area are decoded in parallel and being shifted left by 3 bits, 4 bits or 5 bits to represent the variance of bit rate of each area depending on the predetermined boundary before being summed to get the result of the starting location of any area of compressed image.

20. The apparatus of claim 15, wherein the motion vector of the majority of an image frame is saved to a register for reference of future image frame.
